(19) United States
(12) Patent Application Publication
(10) Pub. No.: US 2007/0122437 A1
(43) Pub. Date: May 31, 2007

(54) Novel insecticide composition and use thereof particularly for impregnating mosquito nets, fly screens and the like

(76) Inventors: Jean-Marc Hougard, Le Croisic (FR); Cedric Pennetier, Montpellier (FR)

Correspondence Address: YOUNG & THOMPSON, 745 SOUTH 23RD STREET, 2ND FLOOR, ARLINGTON, VA, 22202, US

(21) Appl. No.: 10/588,492

(22) PCT Filed: Feb. 4, 2005
(86) PCT No.: PCT/FR05/00262

§ 371 Date: Nov. 9, 2006

Related U.S. Application Data
(60) Provisional application No. 60/541,930, filed on Feb. 6, 2004.

(30) Foreign Application Priority Data
Mar. 25, 2004 (FR) 0403082

(51) Int. Cl. A01N 57/00; A01N 25/00; A01N 43/54; A01N 47/10

(52) U.S. Cl. 424/405; 514/86; 514/121; 514/256; 514/484

(57) ABSTRACT

Materials containing at least one non-pyrethroid insecticide and at least one insect repellent, wherein the concentration of the insecticide is lower than its lethal concentration 100 (LC100) when used alone, for use as combination materials for simultaneous, separate or sequential use in the preparation of an insecticide composition.

The present invention relates to a novel insecticide composition and its use, in particular for the impregnation of mosquito nets.

Mosquitoes are vectors of numerous parasitic or viral diseases, such as for example dengue or yellow fever, which are transmitted by mosquitoes of the Aedes genus. Among these parasitic diseases, malaria, transmitted by mosquitoes of the Anopheles genus, is a particularly serious public health problem.

Thus, of all of the recommended measures for combating these diseases, anti-vectorial measures are a strategy of choice. In the case of malaria, the preferred strategy is that of Mosquito nets Impregnated with Insecticides (MII) (1).

At present, only insecticides of the pyrethroid class are recommended by the World Health Organization (WHO) for the impregnation of mosquito nets (2), due to:
their low toxicity for mammals,
their effectiveness, i.e. the mortality induced, at a low dose,
their moderate cost,
their quick action or Knock-Down effect (KD effect or shock effect),
their irritant effect, which makes them effective even if there is penetration of the
   MII (since the mosquito is irritated when these tarsi come into contact with the insecticide).

No other class of insecticides possesses all of these properties (3).

Pyrethroids are synthesis molecules derived from natural pyrethrins, which are themselves esters of chrysanthemic acid and different alcohols. The latest-generation pyrethroids are either alpha-cyanated molecules (deltamethrin type) or non alpha-cyanated molecules (permethrin type). In all cases, these molecules modify the kinetics of the sodium channels.

However, there is a major obstacle to the use of mosquito nets impregnated with a pyrethroid insecticide: the resistance of mosquitoes to insecticides in general, and to pyrethroids in particular (4), in particular via mutation of the kdr gene (5) which makes these protective measures less effective. It is therefore necessary to find an alternative to pyrethroids while retaining characteristics at least equivalent to those that they present.

The purpose of the present invention is therefore to provide a novel insecticide composition not containing pyrethroid, while being at least as effective as pyrethroid insecticides.

Thus, the present invention relates to products containing
at least one non-pyrethroid insecticide, and
at least one insect repellent,
   the concentration of the insecticide in the product being lower than its lethal concentration 100 (LC100) when it is used alone,
   as combination products for a use that is simultaneous, separated or spread over time in the context of the preparation of an insecticide composition.

According to a particular embodiment of the invention, the concentration of insect repellent in the insecticide composition is lower than the concentration of insect repellent procuring an insecticide effect when it is used alone.

According to another particular embodiment of the invention, the concentration of insect repellent in the product is lower than the concentration of insect repellent procuring a maximum repellent effect when it is used alone.

The invention also relates to an insecticide composition comprising a non-pyrethroid insecticide in combination with an insect repellent, characterized in that the concentration of insecticide in the insecticide composition is lower than its lethal concentration 100 (LC100) when it is used alone.

According to a preferred embodiment, the invention relates to an insecticide composition comprising a non-pyrethroid insecticide in combination with an insect repellent, characterized in that:
the concentration of the insecticide in the composition is lower than its lethal concentration 100 (LC100) when it is used alone, and
the concentration of insect repellent in the insecticide composition is lower than the concentration of insect repellent procuring an insecticide effect when it is used alone.

According to another preferred embodiment of the invention, the concentration of insect repellent in the insecticide composition is lower than the concentration of insect repellent procuring a protective effect when it is used alone.

“Insect repellent” designates a compound capable of having a repellent effect on insects. In particular, when this compound is deposited on a surface it has a repellent effect on insects at a distance from said surface, for a given concentration range. Beneath this range, the insect repellent has only an irritant effect, which requires, in order to exert its action on insects, contact with these insects, in particular via their tarsi, with said surface. Moreover, beyond a certain concentration, an insect repellent can also have an insecticide effect, i.e. toxic vis-à-vis the insects. However, the insect repellent is preferably used at a concentration lower than that procuring an insecticide or toxic effect in the insecticide composition according to the invention. This in particular allows a reduction in the cost and any toxicity for humans of the compositions of the invention.

The repellent effect exerted by an insect repellent can be measured using the following protocol, allowing determination of the percentage of mosquitoes penetrating a surface, such as a textile or a mosquito net, treated with an insect repellent.

Briefly, 5-day old female mosquitoes (50) which have not eaten or drunk anything, are introduced into a cubic cage with 25 cm sides surrounded by a polyester net curtain. On one of the sides of the cage, the net curtain is replaced by a rigid frame of 25×25 cm on which the non-treated (control), then treated surface sample is fixed. The face of the cage carrying the sample is placed for a contact period of 30 minutes on the shaved skin of a rabbit (ventral surface). At the end of the contact period, the females are removed in order to count those which have fed on blood (gorged females). The percentage of gorged females allows characterization of the repellent effect of a given insect repellent, at a given concentration on a given strain of mosquitoes.

Consequently, the concentration of insect repellent in the above composition is lower than that which allows obtaining a <<protective effect>> when the insect repellent is used alone, i.e. a percentage of gorged females of approximately 0% to approximately 20% in the above test.

“Insecticide” designates a compound which is able to have a lethal effect on insects.

“Lethal concentration 100 (LC100)” designates the concentration of an insecticide for which essentially 100% of the insects in contact with this insecticide are killed.

In a similar manner, the lethal concentration X (LCX) corresponds to the concentration of an insecticide for which essentially X% of the insects in contact with this insecticide are killed.

Determination of the LC100 usually takes place according to the standard tube test protocol defined by the World Health Organization (WHO) (6). Briefly, the tube test is composed of an observation tube and an exposure tube (the two tubes are removable) separated by a slide unit equipped with a partition making it possible to obstruct or re-establish the passage between the two tubes. The other end of each tube is sealed by a ventilation plug equipped with a mesh screen. Each tube is lined, for the purposes of the tests, with Whatman paper (standard qualitative filter paper ref 1002 917 or else Whatman N°1) held on the edges by two metal rings. The exposure tube receives paper impregnated with insecticide (impregnated surface on the inside) while the observation tube receives non-impregnated (neutral) paper. In order to impregnate the papers in a homogeneous fashion and to the saturation limit, 2 ml of solution constituted by 0.66 ml of silicone and 1.34 ml of acetone solution are used. For an impregnation at X mg/m², the quantity of active ingredient to be deposited on the paper (12 cm×15 cm i.e. 0.018 m²) is 0.018.X mg of active ingredient (quantity to be adjusted as a function of the degree of purity of the technical product). This quantity of active ingredient is then diluted in 1.34 ml of acetone solution to which 0.66 ml of silicone is then added. The paper dries at ambient temperature, in the dark for 12 hours before the start of the test. The concentrations are expressed in % of active ingredient relative to the volume of silicone on the paper (as the acetone is volatile).

By way of example, a paper impregnated at 1% corresponds to 1 g of active ingredient for 99 g of silicone i.e. 101.02 ml (density 0.98) i.e. 6.93 mg of insecticide for 0.66 ml of silicone (quantity deposited for a paper impregnated with 0.018 m²) i.e. 364 mg/m².

Preferably, the species of mosquito used for determination of the characteristics of an insecticide or an insect repellent is Ae. aegpti, yellow fever and dengue vector mosquito, a strain of which is sensitive and a strain of which is resistant to pyrethroids (100% homozygous for the kdr gene) being available. Advantageously, this mosquito is easier to rear than An. gambiae.

In order to evaluate the mortality and the KD effect, 25 Ae. aegypti females which are not gorged and are from 2 to 5 days old are introduced into the exposure tube and are left in contact for one hour at 27° C.±2 and 80%±10 humidity. The number of mosquitoes which have fallen to the bottom of the tube is noted every 10 minutes. After 60 minutes, the mosquitoes are transferred into the observation tube, with sugared juice and placed in an incubator at 27° C.±2 and 80% ±10 humidity. The mortality is noted at 24 hours. The time at which 50% of the females are knocked-down (KDT50) as well as its confidence interval are determined using a log-probit analysis (7). Four tubes are tested per solution and each test is repeated three times (triple test method).

In order to evaluate the irritant effect or irritability, an Ae. aegypti female which is not gorged and is from 2 to 5 days old is introduced into a polyethylene cone the bottom of which is an impregnated paper. After an adaptation time of 60 seconds, the time for first take-off is noted and recorded as time for First Take-off (or FT). After 256 seconds, if the mosquito has not taken off, the test is stopped. For each test, the flying activity of 50 females is noted, and each test is repeated three times. The females are sorted into classes according to their time for first take-off and the cumulative first take-off frequencies are used in order to calculate the time at which 50% of the females have taken off (FT50). All the tests take place under controlled conditions, at 27° C.±2 and 80% ±10 humidity.

Advantageously, the combination of the non-pyrethroid insecticide and the insect repellent has synergistic effects on the mortality and the KD effect. This means that the effects induced by the composition are greater than the sum of the effects induced by the non-pyrethroid insecticide and the insect repellent separately.

Moreover, the insecticide composition defined above produces an additive effect on the irritant effect induced by the non-pyrethroid insecticide and the insect repellent. The synergistic effects on the mortality and the KD effect as well as the additive effect on the irritant effect thus gives the insecticide composition of the invention characteristics similar to those of pyrethroids.

Advantageously, the insecticide composition defined above is active on a large number of different mosquito species, such as Ae. aegypti, An. gambiae or also Culex quinquefasciatus mosquitoes.

Advantageously, the insecticide composition defined above is active on mosquitoes resistant to insecticides, in particular those resistant to pyrethroids.

Advantageously, the insecticide composition of the invention is not toxic for mammals, in particular for humans.

The present invention also relates to the use of an insect repellent in combination with an insecticide for the preparation of an insecticide composition having a KD effect and/or an insecticide effect greater than that of said insecticide alone.

According to another embodiment of the invention, the above products and insecticide composition can comprise several insecticides and several insect repellents.

According to a particular embodiment of the invention, the concentration of the insecticide in the insecticide composition is comprised from approximately its LC20 to approximately its LC40 when it is used alone.

According to a preferred embodiment, the concentration of the insecticide in the insecticide composition approximately corresponds to its LC30 when it is used alone.

According to another embodiment, the weight ratio between the concentration of insecticide and the concentration of insect repellent in the insecticide composition is approximately 1/100 to approximately 1/10.

Advantageously, the ratios defined above make it possible to obtain the most significant synergistic effects defined above .

According to a particular embodiment, the insecticide is chosen from:

a carbamate, such as:

alanycarb: S-methyl-N[[N-methyl-N-[N-benzyl-N(2-ethoxy-carbonylethyl)aminothio]carbamoyl]thioacetimidate,
bendiocarb: 2,2-dimethyl-1,3-benzodioxol-4yl-methylcarbamate),
carbaryl: 1-naphthyl N-methylcarbamate,
isoprocarb: 2-(1-methylethyl)phenylmethylcarbamate,
carbosulphan: 2,3 dihydro-2,2-dimethyl-7-benzofuranyl[(dibutylamino)thio]methylcarbamate,
fenoxycarb: ethyl[2-(4-phenoxyphenoxy)ethyl]carbamate,
indoxacarb: methyl-7-chloro-2,3,4a,5-tetrahydro-2-[methoxycarbonyl(-4 trifluoromethoxyphenyl)]
propoxur: 2-isopropyloxyphenolmethylcarbamate,
pirimicarb: 2-dimethylamino-5,6-dimethyl-4-pyrimidinyl-dimethylcarbamate,
thidiocarb: dimethyl N,N′(thiobis((methylimino)carbonoyloxy)bisethanimidiothioate),
methomyl: S-methyIN-((methylcarbamoyl)oxy)thioacetamidate,
ethiofencarb: 2-((ethylthio)methyl)phenylmethylcarbamate,
fenothiocarb: S-(4-phenoxybutyl)-N,N-dimethyl thiocarbamate,
cartap: S, S′-(2-5dimethylamino)trimethylene)bis(thiocarbamate)hydrochloride,
fenobucarb: 2-sec-butylphenylmethylcarbamate,
XMC: 3,5-dimethylphenyl-methyl carbamate,
xylylcarb: 3,4-dimethylphenylmethyl carbamate;
   an organophosphate such as:
fenitrothion: O, O-dimethylO-(4-nitro-m-tolyl)phosphorothioate,
diazinon: O,O-diethyl-O-(2-isopropyl-6-methyl-4-pyrimidinyl)phosphorothioate,
pyridaphenthion: O-(1,6-dihydro-6-oxo-1-phenylpyrazidin-3-yl)O,O-diethyl phosphorothioate,
pirimiphos-ethyl: O,O-diethyl O-(2-(diethylamino)6-methyl-pyrimidinyl)phosphorothioate,
pirimiphos-methyl: O-[2-(diethylamino)-6-methyl-4pyrimidinyl]O,O-dimethyl phosphorothioate,
etrimphos: 0-6-ethoxy-2-ethyl-pyrimidin-4-yl-O,O-dimethyl-phosphorothioate,
fenthion: O,O-dimethyl-O-[-3-methyl4-(methylthio)phenyl phosphorothioate,
phoxim: 2(diethoxyphosphinothoyloxyimino)-2-phenylacetonitrile,
chlorpyrifos: O,O-diethyl-O-(3,5,6-trichloro-2-pyrinyl)phosphorothioate,
chlorpyrifos-methyl: O,O-dimethyl O-(3,5,6-trichloro-2-pyridinyl) phosphorothioate,
cyanophos: O,O dimethylO-(4cyanophenyl)phosphorothioate,
pyraclofos: (R,S)[4-chlorophenyl)-pyrazol-4-yl]-O-ethyl-S-n-propylphosphorothioate,
acephate: O,S-dimethyl acetylphosphoroamidothioate,
azamethiphos: S-(6-chloro-2,3-dihydro-oxo-1,3-oxazolo[4,5-b]pyridin-3-ylmethyl phosphorothioate,
malathion: O,O-dimethyl phosphorodithioate ester of diethyl mercaptosuccinate,
temephos: (O,O′(thiodi4-1-phenylene)O, O, O, O-tetramethyl phosphorodithioate,
dimethoate: ((O,O-dimethyl S-(n-methylcarbamoylmethyl)phosphorodithioate,
formothion: S[2-formylmethylamino]-2-oxoethyl]-O,O-dimehyl phosphorodithioate,
phenthoate: O,O dimethyl S-(alpha-ethoxycarbonylbenzyl)-phosphorodithioate; or
   an insecticide having a sterilizing effect on adult mosquitoes such as:
1- (alfa-4-(chloro-alpha-cyclopropylbenzylidenamino-oxy)-p-tolyl)-3-(2,6-diflourobenzoyl) urea,
diflubenzuron: (((3,5-dichloro-4-(1,1,2,2-tetraflouroethoxy)phenylamino)carbonyl)2,6 diflouro benzamide,
triflumuron: 2-Chloro-N-(((4-(triflouromethoxy)phenyl)-amino-)carbonyl)benzamide, or a triazine such as N-cyclopropyl-1,3,5-triazine-2,4,6-triamine.

According to another particular embodiment, the insect repellent is chosen from:
N,N-diethyl-meta-toluamide (DEET),
N-butyl-N-acetyl-3-ethylamine propionate (35/35®, Merck)
2-(2-hydroxy-ethyl)-piperidine carboxylic acid ester of 1-methyl-propyl (Bayrepel®, Bayer) N,N-diethylphenylacetamide (DEPA),
1-(3-cyclohexen-1-yl-carbonyl)-2-methylpiperine,
(2 hydroxymethylcyclohexyl) acetic acid lactone,
2-ethyl-1,3-hexandiol,
indalone,
methylneodecanamide (MNDA), or
an insect repellent derived from a plant extract such as limonene, citronella, eugenol, (+) eucamalol (1), (−)-1-epi-eucamalol,
   or a crude extract from plants such as Eucalyptus maculata, Vitex rotundifolia, or Cymbopogan.

According to a particularly preferred embodiment, the insecticide is propoxur.

According to another particularly preferred embodiment, the insecticide is chlorpyrifos-methyl.

According to a particularly preferred embodiment, the insect repellent is DEET.

According to another particularly preferred embodiment, the insect repellent is N-butyl-N-acetyl-3-ethylamine propionate (35/35®).

According to yet another particularly preferred embodiment, the insect repellent is 2-(2-hydroxy-ethyl)-piperidine carboxylic acid ester of 1-methyl-propyl (Bayrepel®).

According to a particular embodiment, the insecticide is propoxur and the insect repellent is DEET, the propoxur being present at the concentration of approximately 1 to approximately 20 mg/m², preferably approximately 7.3 mg/m², and DEET being present at the concentration of approximately 50 to approximately 1000 mg/m², in particular of approximately 100 to approximately 500 mg/m², preferably approximately 360 mg/m².

Advantageously, this composition presents a KD effect and a mortality greater than that which can be measured under the same conditions for deltamethrin, a reference pyrethroid insecticide, at the concentration of 0.728 mg/m² and an irritability at least equal to that which can be measured under the same conditions for deltamethrin at the concentration mentioned above.

Advantageously the composition comprising propoxur at approximately 7.3 mg/m² and DEET at approximately 360 mg/m² presents a greater mortality and KD effect under the same conditions as that of deltamethrin at approximately 3.6 mg/m².

The invention also relates to the use of an insecticide composition as defined above, for the preparation:
of formulations, such as aerosols, lotions, creams, microcapsules, wettable powders, suspensions, liquid concentrates, emulsifiable concentrates, or
of fabrics comprising said composition, in particular of fabrics impregnated with said composition, such as impregnated mosquito nets.

Aerosols containing an insecticide composition of the invention can be prepared using techniques well known to a person skilled in the art. In particular the additives required for the preparation of aerosols are particularly well known to a person skilled in the art. Such aerosols advantageously allow the spraying of the composition of the invention into the air of a room for example, in order to protect the occupants of said room from mosquito bites, in particular from mosquitoes resistant to pyrethroids.

Lotions containing an insecticide composition of the invention can be prepared using techniques well known to a person skilled in the art. In particular the additives and excipient required for the preparation of lotions are particularly well known to a person skilled in the art. Such lotions are particularly useful for an application directly onto the skin in order to prevent mosquito bites, in particular from mosquitoes resistant to pyrethroids.

Formulations other than aerosols and lotions (creams, microcapsules) or sustained release formulations (wettable powders, concentrated suspensions, liquid concentrates, emulsifiable concentrates) and which contain an insecticide composition of the invention can be prepared using techniques well known to a person skilled in the art. In particular, the additives and excipient required for the preparation of these formulations are particularly well known to a person skilled in the art. Such formulations are particularly useful for an impregnation of mosquito nets, either by soaking in the formulation, or by spraying, or by pre-impregnation before weaving, in order to prevent mosquito bites, in particular from mosquitoes resistant to pyrethroids.

The methods for the preparation of fabrics, in particular of mosquito nets, either by adding the insecticide composition of the invention to the products used for the synthesis of synthetic textile fibres, or by impregnation of the fabrics, or of the fibres of fabrics before weaving, using the composition of the invention, are well known to a person skilled in the art and have been widely described (8).

Advantageously, the impregnation is carried out in such a way that it withstands successive washings of the impregnated fabrics, which avoids having to re-impregnate these fabrics.

In this regard, the present invention also relates to fabrics protecting against insects, in particular mosquito nets, characterized in that they include an insecticide composition as defined above.

The advantages of mosquito nets impregnated with insecticides, in particular with pyrethroid insecticides, have been described in depth (1). The mosquito nets according to the invention are particularly useful in areas infested with mosquitoes in which resistance to pyrethroids is common.

The invention also relates to products containing
propoxur, and
DEET
   propoxur being present at the concentration of approximately 1 to approximately 20 mg/m², preferably approximately 7.3 mg/m², and DEET being present at the concentration of approximately 50 to approximately 1000 mg/m², in particular approximately 100 to approximately 500 mg/m², preferably approximately 360 mg/m², as combination products for a use which is simultaneous, separated or spread over time in the context of the preparation:
of formulations, such as aerosols, lotions, creams, microcapsules, wettable powders, suspensions, liquid concentrates, emulsifiable concentrates, or
of fabrics comprising said composition, in particular fabrics impregnated with said composition, such as impregnated mosquito nets.

### DESCRIPTION OF THE FIGURES

FIG. 1

Determination of Irritability

FIG. 1 represents the percentage of mosquitoes having taken off for the first time after an adaptation time of 60 seconds (ordinate axis on the left) as a function of the logarithm of the time elapsed (abscissa axis, in seconds) for deltamethrin at 5.1 mg/m² (curve 1), the propoxur 7.28 mg/m²+DEET 364 mg/m² mixture (curve 2, circles), DEET alone at 364 mg/m² (curve 3, cross), deltamethrin at 0.728 mg/m² (curve 4, squares), propoxur alone at 7.28 mg/m² (curve 5, diamonds) and the control impregnated with a solution of 2 ml of acetone and silicone but without insecticide (curve 6, triangles).

FIG. 2

Determination of the KD Effect

FIG. 2 represents the percentage (probit scale) of mosquitoes knocked down (ordinate axis) as a function of the logarithm of the time elapsed (abscissa axis, in minutes) for deltamethrin at 5.1 mg/m² (curve 1), deltamethrin at 3.64 mg/m² (curve 2, circles), the 1/50 propoxur 7.28 mg/m² +DEET 364 mg/m² mixture (curve 3, squares), propoxur alone at 7.28 mg/m² (curve 4, cross), and DEET alone at 364 mg/m² as well as the control impregnated with a solution of 2 ml of acetone and silicone but without insecticide (curves 5 and 6).

FIG. 3

Determination of the Remanence

FIG. 3 represents the percentage of gorged mosquitoes (ordinate axis) as a function of the time (abscissa axis, in days). The black histograms represent the percentage of gorged mosquitoes in the presence of a control fabric, the white histograms the percentage of gorged mosquitoes in the presence of a fabric impregnated with an insecticide, pirimiphos-methyl, the vertically hatched histograms the percentage of gorged mosquitoes in the presence of a fabric impregnated with an insect repellent, Bayrepel®, and the horizontally hatched histograms the percentage of gorged mosquitoes in the presence of the mixture of the insecticide and the insect repellent. The lower the percentage of gorged mosquitoes, the greater the protective effect.

### EXAMPLES

### Example 1

The effects of a mixture comprising:
a non-pyrethroid insecticide, propoxur, a carbamate having rapid efficacy but no KD effect (Knock Down, shock effect) and low irritability, and
an insect repellent: N-N-Diethyl-M-Toluamide (DEET), a commonly used repellent,
   were studied on Ae. aegypti females (the dengue and yellow fever vector species), from 2 to 5 days old, which are not gorged, and compared to those obtained with a positive control, deltamethrin, a reference pyrethroid insecticide.

Two strains of Ae. aegypti females were used, a strain sensitive to pyrethroids, and a resistant strain, homozygous for the kdr gene, one of the genes responsible for resistance to pyrethroids.

A. Methodology

Three types of measurements were carried out: measurement of mortality, measurement of the KD effect and measurement of irritability.

1. Measurement of Mortality and KD Effect

The tests for measuring the mortality and the KD effect were carried out using tube tests (25 females per tube, 4 tubes per concentration of insecticide and/or insect repellent tested, contact time 1 hour, reading the KD from 10 to 60 min, reading the mortality after 24 hours) according to the following protocol.

The tarsal contact tests were implemented using filter paper (standard qualitative filter paper ref 1002 917 or else Whatman N° 1) impregnated with technical quality products according to the recommendations of the World Health Organization (WHO, 6). The filter papers were treated using solutions of insecticide and/or insect repellent diluted in acetone with silicone oil as support. The impregnation of the paper was carried out with 2 ml of the solutions to be tested, then the paper was dried for 12 h. The mortality and the KD effect resulting from the tarsal contacts with treated filter paper were measured using the adult mosquito test tubes of the WHO. The concentrations were expressed in weight of active ingredient relative to the surface of treated filter paper surface. Batches of 25 Ae. aegypti females which have not fed on blood, from 2 to 5 days old, were introduced into holding tubes and kept for 1 h (adaptation time) at 27±2° C. and 80±10% humidity. The mosquitoes were then transferred into the exposure tube and placed under dimmed light for 1 h. For the purpose of comparison with pyrethroids, which are rapid action insecticides, the number of mosquitoes knocked down at the bottom of the tubes was counted at regular intervals of 10 min. The time at which 50% of the mosquitoes are knocked down (KDT₅₀) and its confidence interval at 95% were then determined using the log-probit method (7). The mortality was recorded after 24 hours of exposure. Each concentration was tested four times and each test was repeated three times with different groups of insects in order to consider inter-batch variability.

2. Measurement of Irritability

The irritability tests were carried out (a female in a cone in contact with the impregnated surface, reading of the time for first take-off after the Ist minute has passed, 50 females per test) according to the following protocol.

Ae. aegypti females which have not fed on blood, from 2 to 5 days old, were introduced individually into plastic cones applied to treated filter papers. After an adaptation time of exactly 60 seconds, the time which has passed between the first landing and the next take-off was defined as being <<the first take-off time>> (FT). The observation was not extended for the rare mosquitoes which had not taken off after 256 seconds. For each test, 50 mosquitoes were tested individually. A simple computer program using the internal clock of a laptop computer was used in order to carry out this test and in order to analyze the results grouping the mosquitoes into classes for time of first take-off. The time at which 50% of the mosquitoes have left the treated surface (median first take-off time, FT₅₀) and its confidence interval at 95% were then determined using the log-probit method.

B. Results

Prior to the measurements, the lethal concentration 30 (LC30), the concentration of insecticide at which 30% of the mosquitoes are killed, was determined for propoxur (7.28 mg/m²). This concentration is the best for demonstrating interactions between the insecticide and the insect repellent. The lethal concentration 30 (LC30) was also determined for deltamethrin (0.728 mg/m²) in order to be able to compare the KD effect and the irritant effect of these two insecticides at the concentration killing the same percentage of insects.

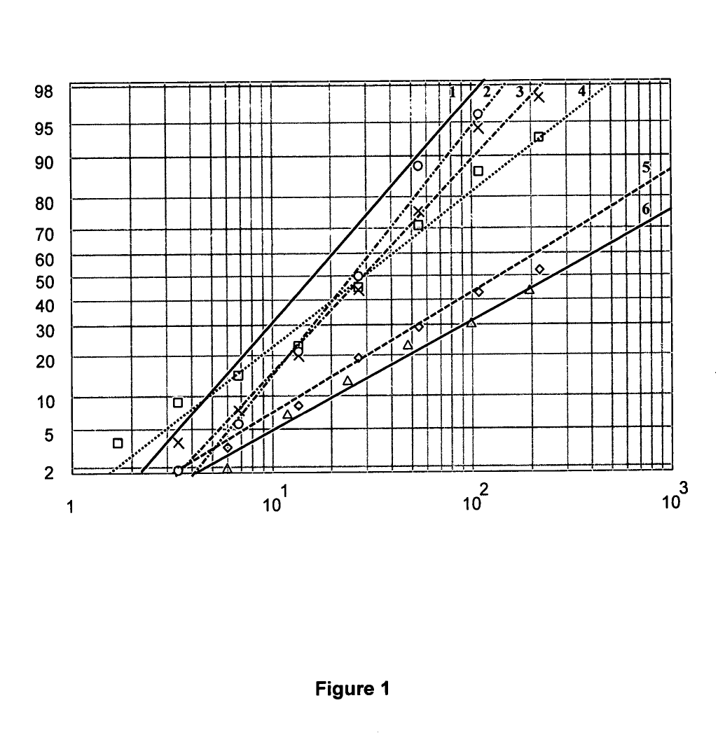

The irritability was determined at the LC30 for each insecticide, propoxur and deltamethrin, individually, for DEET alone at the concentration of 364 mg/m², as well as for the propoxur (LC30, 7.28 mg/m²)+DEET (364 mg/m²) mixture (ratio 1/50) (FIG. 1). The irritability was also determined at the LC100 of deltamethrin, in order to compare the characteristics of the insecticide composition with those of deltamethrin both at the LC30 and at the LC100.

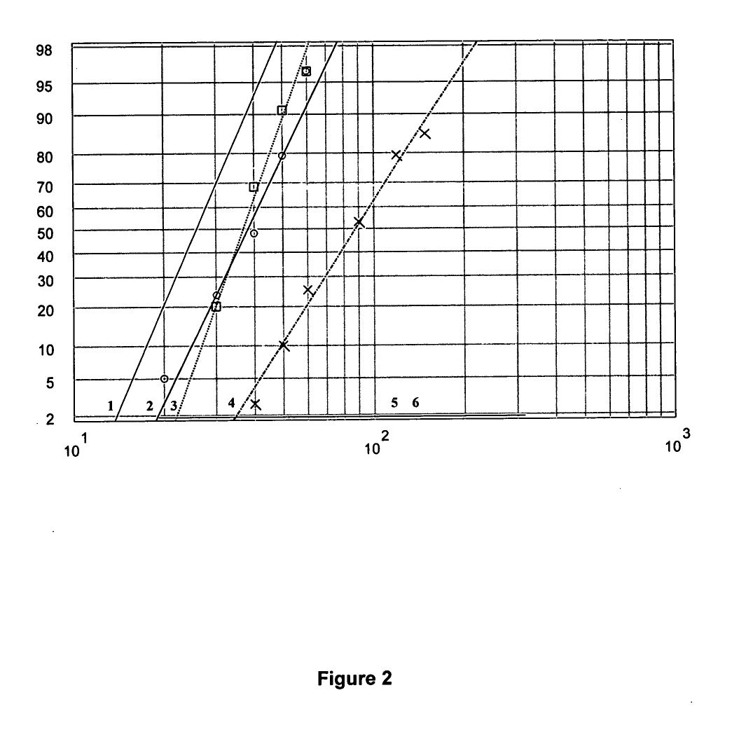

The KD effect and the mortality were determined at the LC30 for each insecticide, propoxur and deltamethrin, individually, for DEET alone at the concentration of 364 mg/m², as well as for the propoxur (LC30, 7.28 mg/m²) +DEET (364 mg/m²) mixture (ratio 1/50) (FIG. 2). The KD effect was also determined at the LC100 of deltamethrin, in order to compare the characteristics of the insecticide composition with those of deltamethrin both at the LC30 and at the LC100.

The results obtained are shown in Table 1, below:

TABLE 1
first take-off time, KD effect and mortality of Aedes aegypti females, strain
sensitive to pyrethroids, in the presence of an insecticide, an insect repellent
and the mixture of the two on impregnated paper.

| | Irritability | | KD Effect | | |
|---|---|---|---|---|---|
| Compounds tested | FT₅₀ (s) | 95% CI¹ | KDT₅₀ (min) | 95% CI¹ | Mortality |
| Propoxur 7.28 mg/m² | 133.9 | 108.8-172.3 | 86.9 | 82.9-91.3 | 34% (300) |
| DEET 364 mg/m² | 24.2 | 21.9-26.8 | — | — | 0% (300) |
| Propoxur 7.28 mg/m² + DEET | 21.5 | 18.7-24.6 | 36.6 | 35.7-37.4 | 96% (300) |
| 364 mg/m² (ratio 1/50) | | | | | |
| Reference pyrethroid: | 23.9 | 21.2-27 | 52.8 | 51.4-54.38 | 34% (300) |
| deltamethrin 0.728 mg/m² | | | | | |
| Reference pyrethroid: | 16.9 | 14.2-20.4 | 23.5 | 20.2-27.3 | 100% (200) |
| deltamethrin at 5.1 mg/m² | | | | | |

¹95% CI = confidence interval at 95% - ( ) number of mosquitoes tested - n.m. not measured

The results indicate:
an additive effect of the propoxur 7.28 mg/m²+DEET 364 mg/m² mixture on irritability, the irritability of the mixture being greater than that obtained for deltamethrin at 0.728 mg/m² and close to that obtained for deltamethrin at LC100 (5.1 mg/m²);
a synergistic effect of the propoxur+DEET mixture on the KD effect, which effect is particularly unexpected as DEET does not itself have any KD effect;
a synergistic effect of the propoxur+DEET mixture on the mortality, which effect is particularly unexpected as DEET does not itself have any insecticide effect.

The insecticide composition obtained (non-pyrethroid insecticide+repellent) therefore allows reproduction of the characteristics of the pyrethroid insecticides (in particular as regards irritability and the KD effect) while having effects equivalent to or greater than those obtained with pyrethroid insecticides at approximately the same doses.

The results obtained for the mixture described above were also validated with an Ae. aegypti strain resistant to pyrethroids with the same experimental procedures. These results are presented in Table 2 below:

TABLE 2
first take-off time, KD effect and mortality of Aedes aegypti females, a strain
resistant to pyrethroids, in the presence of an insecticide, an insect repellent and the mixture
of the two on impregnated paper.

| | Irritability | | KD Effect | | |
|---|---|---|---|---|---|
| Compounds tested | FT₅₀ (s) | 95% CI¹ | KDT₅₀ (min) | 95% CI¹ | Mortality |
| Reference pyrethroid: | 34.98 | 28.3-43.7 | — | — | 8% (200) |
| deltamethrin at 5.1 mg/m² | | | | | |
| Propoxur 3.64 mg/m² | n.m. | n.m. | 88.4 | 77.6-114 | 34.5% (275) |
| DEET 364 mg/m² | n.m. | n.m. | — | — | 0% (300) |
| Propoxur 3.64 mg/m² + DEET 364 mg/m² | 17.3 | 14.3-21.5 | 41.5 | 40.6-42.4 | 94.6% (300) |
| (ratio 1/100) | | | | | |

¹95% CI = confidence interval at 95% - ( ) number of mosquitoes tested - n.m. not measured
NB: compared to the sensitive strain, the propoxur concentration was reduced for the resistant strain in order to allow a more marked sensitivity to this insecticide; in fact the LC30 is attained for 3.64 mg/m² of propoxur for the resistant strain and for 7.28 mg/m² for the sensitive strain.

It is therefore noted that the non-pyrethroid insecticide+repellent mixture of the invention (propoxur+DEET) allows the effects of a pyrethroid type insecticide to be reproduced and even on insects resistant to pyrethroids, this phenomenon in particular being due to a synergistic effect which was not expected for this combination on mortality and on the KD effect.

The results obtained for the mixture described above were also validated for other species of mosquitoes, namely Anopheles gambiae and Culex quinquefasciatus with the same experimental procedures.

Similarly, the effects described above for the propoxur+DEET mixture were also able to be observed in Anopheles gambiae mosquitoes, mutated for the kdr gene, resistant to pyrethroids, as well as in Culex quinquefasciatus mosquitoes resistant to insecticides of the organophosphate and carbamate type.

Moreover, similar results were able to be obtained with another insecticide, chlorpyrifos-methyl (Dow Agrosciences), as well as by using two other insect repellents, 35/35® (Merck) and Bayrepel® (Bayer).

Finally, all these results were able to be validated by impregnation of mosquito nets using cone tests defined by the WHO (9) and by tests which simulate natural conditions (<<tunnel tests>>, 10).

### Example 2

The inventors have also studied the remanence of a mixture according to the invention on an impregnated fabric.

A. Methodology

The insecticide used in this study is an organophosphate, pyrimifos-methyl (O-[2-(diethylamino)-6-methyl-4-pyrimidinyl] O,O-dimethyl-phosphorothioate), and the insect repellent is Bayrepel®(or KBR 3023, 2-(2-hydroxy-ethyl)-piperidine carboxylic acid ester of 1-methyl-propyl).

In accordance with the insect repellent test protocol described previously, squares of 100% cotton fabric with 25 cm sides with a 5 cm diameter circular hole at their centre were used. The retentive power of this fabric is 486.6 mg/m², 25.56 mL of a formulation of pyrimifos-methyl (emulsifiable concentrate at 1000 mg/m²), of KBR 3023 (repellent at 10000 mg/m²), or the mixture of the two were then applied to each sample.

50 females which have not eaten or drunk anything of the Ae. aegypti strain which is sensitive when fasting and from 5 to 10 days old are introduced into a cage (25 cm×25 cm) constituted by a rigid metal frame surrounded on three sides by a polyester net curtain and by the square of fabric on the fourth side. The cage is placed on the previously shaved stomach of a rabbit on the fabric side. The contact is then maintained for 30 minutes after which the cage is removed. Counting the gorged females is then carried out. This test is carried out in parallel on 4 rabbits: a control, one for the insecticide alone, one for the insect repellent alone and one for the mixture.

This operation is repeated regularly over several days without re-impregnation of the fabric in order to estimate the efficacy and the remanence of the impregnation products.

The efficacy of the mixture as well as its remanence are estimated by determination of the percentage of gorged mosquitoes compared with the insecticide alone or the insect repellent alone, over time.

B. Results

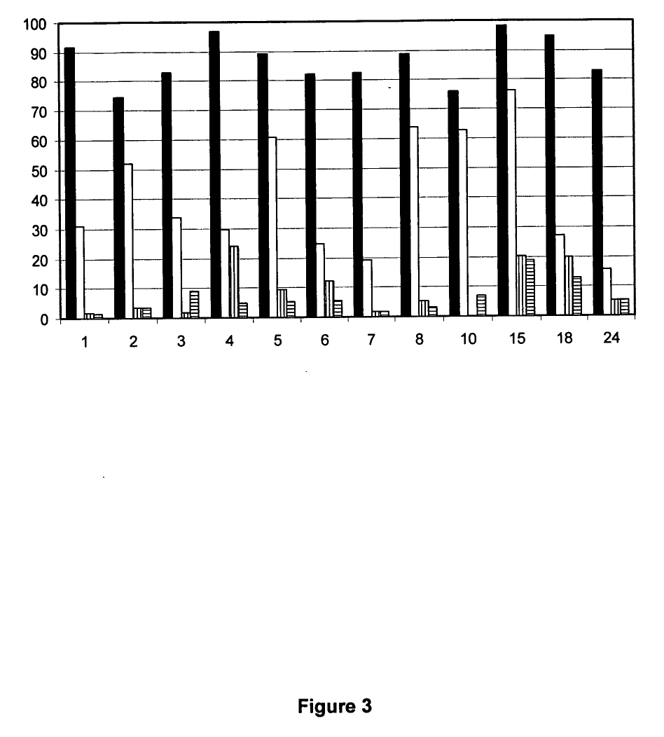

The results obtained are presented in FIG. 3. It is seen, in particular, that the efficacy of the mixture is greater than that of the insecticide alone or of the insect repellent alone. Moreover, the protective effect of the mixture is maintained for at least 24 days. Therefore, on the 24^{th} day the mixture still provides efficacy of protection of 93% in relation to the control.

### REFERENCES

1. D'Alessandro U. and Coosemans M., 1997. Concerns on long-term efficacy of an insecticide-treated bednet programme on child mortality. Parasitology Today, 13: 124-125.
2. Zaim M., Aitio A. and Nakashima N. 2000. Safety of pyrethroid-treated nets. Medical and Veterinary Entomology, 14: 1-5.
3. Tomlin C. D. S., 2000. The Pesticide Manual, a World Compendium, 12th Ed. British Crop Protection Council, London, United Kingdom.
4. Sina B. J. and Aultman S. K., 2001. Resisting resistance. Trends in Parasitology, 17: 305-306.
5. Martinez-Torres D., Chandre F., Williamson M. S., Darriet F., Bergé J. B., Devonshire A. L., Guillet P., Pasteur N. and Pauron D., 1998. Molecular characterization of pyrethroid knockdown resistance (kdr) in the major malaria vector Anopheles gambiae s.s. Insect Mol. Biol., 7: 179-184.
6. [WHO] World Health Organization. 1998b. Test procedures for insecticide resistance monitoring in malaria vectors, bio-efficacy and persistence of insecticides ion treated surfaces. WHO document WHO/CDSIMAL/98.12. Geneva, Switzerland.
7. Raymond M., Prato G. and Ratsira D., 1997. Probit and logit analysis program version 2.0. Praxème: R&D.
8. Guillet P., 2001. Insecticide-treated nets in Africa: where do we stand? Africa Health, Malaria Supplement, 23(6): 20-23.
9. [WHO] World Health Organization. 1998b. Test procedures for insecticide resistance monitoring in malaria vectors, bio-efficacy and persistence of insecticides ion treated surfaces. WHO document WHO/CDS/MAL/98.12. Geneva, Switzerland.
10. Chandre, F., F. Darriet, S. Duchon, L. Finot, S. Manguin, P. Carnevale and P. Guillet. 2000. Modifications of pyrethroid effects associated with Kdr mutation in Anopheles gambiae. Med. Vet. Entomol. 14: 81-88.

1. Products containing
at least one non-pyrethroid insecticide, and
at least one insect repellent,
the concentration of the insecticide in the product being lower than its lethal concentration 100 (LC100) when it is used alone, and the concentration of the insect repellent in the product being lower than the concentration of the insect repellant procuring a maximum repellent effect when it is used alone,
as combination products for a use that is simultaneous, separated or spread over time in the preparation of an insecticide composition.

2. Insecticide composition comprising a non-pyrethroid insecticide in combination with an insect repellent, characterized in that:
the concentration of insecticide in the composition is lower than its lethal concentration 100 (LC100) when it is used alone, and
the concentration of insect repellent in the insecticide composition is lower than the concentration of insect repellent procuring an a protective effect when it is used alone.

3. (canceled)

4. Insecticide composition according to claim 2, characterized in that the concentration of insecticide in the insecticide composition is comprised from approximately its LC20 to approximately its LC40 when it is used alone.

5. Insecticide composition according to claim 2, characterized in that the concentration of the insecticide in the insecticide composition corresponds appoximately to its LC30 when it is used alone.

6. Insecticide composition according to claim 2, characterized in that the weight ratio of the insecticide concentration and the insect repellent concentration in said insecticide composition is approximately 1/100 to approximately 1/10.

7. Insecticide composition according to claim 2, in which the insecticide is chosen from:
a carbamate such as:
alanycarb: S-methyl-N[[N-methyl-N-[N-benzyl-N (2-ethoxy-carbonylethyl)aminothio]carbamoyl]thioacetimidate,
bendiocarb: 2,2-dimethyl-1,3-benzodioxol-4yl-methylcarbamate),
carbaryl: 1-naphthyl N-methylcarbamate,
isoprocarb: 2-(1-methylethyl)phenylmethylcarbamate,
carbosulphan: 2,3 dihydro-2,2-dimethyl-7-benzofuranyl[(dibutylamino)thio]methylcarbamate,
fenoxycarb: ethyl[2-(4-phenoxyphenoxy)ethyl]carbamate,
indoxacarb: methyl-7-chloro-2,3,4a,5-tetrahydro-2-[methoxycarbonyl(-4trifluoromethoxyphenyl)]
propoxur: 2-isopropyloxyphenolmethylcarbamate,
pirimicarb: 2-dimethylamino-5,6-dimethyl-4-pyrimidinyl-dimethylcarbamate,
thidiocarb: dimethyl N,N′(thiobis((methylimino)carbonoyloxy) bisethanimidiothioate),
methomyl: S-methylN-((methylcarbamoyl)oxy)thioacetamidate,
ethiofencarb: 2-((ethylthio)methyl)phenylmethylcarbamate,
fenothiocarb: S-(4-phenoxybutyl)-N,N-dimethylthiocarbamate,
cartap: S, S′-(2-5dimethylamino)trimethylene)bis (thiocarbamate)hydrochloride,
fenobucarb: 2-sec-butylphenylmethylcarbamate,
XMC: 3,5-dimethylphenyl-methylcarbamate,
xylylcarb: 3,4-dimethylphenylmethylcarbamate;
an organophosphate such as:
fenitrothion: O,O-dimethyl O-(4-nitro-m-tolyl)phosphorothioate,
diazinon: O,O-diethyl-O-(2-isopropyl-6-methyl-4-pyrimidinyl) phosphorothioate,
pyridaphenthion: O-(1,6-dihydro-6-oxo-1-phenylpyrazidin-3-yl) O,O-diethylphosphorothioate,
pirimiphos-ethyl: O,O-diethyl O-(2-(diethylamino)6-methyl-pyrimidinyl) phosphorothioate,
pirimiphos-methyl: O-[2- (diethylamino)-6-methyl-4pyrimidinyl]O,O-dimethyl phosphorothioate,
etrimphos: O-6-ethoxy-2-ethyl-pyrimidin-4-yl-O, O-dimethyl-phosphorothioate,
fenthion: O,O-dimethyl-O-[-3-methyl4-(methylthio) phenyl phosphorothioate,
phoxim: 2 (diethoxyphosphinothoyloxyimino)-2-phenylacetonitrile,
chlorpyrifos: O,O-diethyl-O-(3,5,6-trichloro-2-pyrinyl) phosphorothioate,
chlorpyrifos-methyl: O,O-dimethyl O-(3,5,6-trichloro-2-pyridinyl)phosphorothioate,
cyanophos: O,O dimethyl O-(4cyanophenyl)phosphorothioate,
pyraclofos: (R, S)[4-chlorophenyl)-pyrazol-4-yl]-O-ethyl-S-n-propyl phosphorothioate,
acephate: O,S-dimethylacetylphosphoroamidothioate,
azamethiphos: S-(6-chloro-2,3-dihydro-oxo-1,3-oxazolo [4,5-b] pyridin-3-yl methyl phosphorothioate,
malathion: O,O-dimethyl phosphorodithioate ester of diethyl mercaptosuccinate,
temephos: (O,O′(thiodi-4-1-phenylene) O,O,O,O-tetramethyl phosphorodithioate,
dimethoate: ((O,O-dimethyl S-(n-methylcarbamoylmethyl) phosphorodithioate,
formothion: S [2-formylmethylamino)-2-oxoethyl]-O,O-dimehyl phosphorodithioate,
phenthoate: O,O dimethyl S-(alpha-ethoxycarbonylbenzyl)-phosphorodithioate; or
an insecticide having a sterilizing effect on adult mosquitoes such as:
1-(alfa-4- (chloro-alpha-cyclopropylbenzylidenamino-oxy)-p-tolyl)-3-(2,6-diflourobenzoyl) urea,
diflubenzuron: (((3,5-dichloro-4-(1,1,2,2-tetraflouroethoxy) phenylamino)carbonyl) 2,6diflourobenzamide,
triflumuron: 2-Chloro-N-(((4-(triflouromethoxy)phenyl)-amino-) carbonyl) benzamide, or a triazine such as N-cyclopropyl-1,3,5-triazine-2,4,6-triamine.

8. Insecticide composition according to claim 2, wherein the insect repellent is chosen from:
N,N-diethyl-meta-toluamide (DEET),
N-butyl-N-acetyl-3-ethylamine propionate (35/35®, Merck)
2-(2-hydroxy-ethyl)-piperidinecarboxylic acid ester of 1-methyl-propyl (Bayrepel®, Bayer)
N,N-diethylphenylacetamide (DEPA),
1-(3-cyclohexen-1-yl-carbonyl)-2-methylpiperine,
(2 hydroxymethylcyclohexyl) acetic acid lactone,
2-ethyl-1,3-hexandiol,
indalone,
methylneodecanamide (MNDA), or
an insect repellent derived from a plant extract such as limonene, citronella, eugenol, (+) eucamalol (1), (−)-1-epi-eucamalol,
or a crude extract from plants such as Eucalyptus maculata, Vitex rotundifolia, or Cymbopogan.

9. Insecticide composition according to claim 2, wherein the insecticide is propoxur.

10. Insecticide composition according to claim 2, wherein the insect repellent is DEET.

11. Insecticide composition according to claim 2, wherein the insecticide is propoxur and the insect repellent is DEET, propoxur being present at the concentration of approximately 1 to approximately 20 mg/m², preferably approximately 7.3 mg/m², and DEET being present at the concentration of approximately 50 to approximately 1000 mg/m², in particular of approximately 100 to approximately 500 mg/m², preferably approximately 360 mg/m².

12. Method for preparing:
formulations, such as aerosols, lotions, creams, microcapsules, wettable powders, suspensions, liquid concentrates, emulsifiable concentrates, or
fabrics comprising an insecticide composition as defined in claim 2, in particular fabrics impregnated with said composition, by the use of an insecticide composition as defined in claim 2.

13. Fabrics protecting against insects, in particular mosquito nets or clothes, characterized in that they comprise an insecticide composition as defined in claim 2.

14. Products according to claim 1, containing
propoxur, and
DEET
the propoxur being present at the concentration of approximately 1 to approximately 20 mg/m², preferably approximately 7.3 mg/m², and DEET being present at the concentration of approximately 50 to approximately 1000 mg/m², in particular approximately 100 to approximately 500 mg/m2, preferably approximately 360 mg/m², as combination products for a use that is simultaneous, separated or spread over time in the context of the preparation:
of formulations, such as aerosols, lotions, creams, microcapsules, wettable powders, suspensions, liquid concentrates, emulsifiable concentrates, or
of fabrics comprising said composition, in particular of fabrics impregnated with said composition, such as impregnated mosquito nets or impregnated clothes.

15. method for preparing mosquito nets impregnated with the insecticide composition as defined in claim 2 or clothes impregnated with the insecticide composition as defined in claim 2.
